(19) United States
(12) Patent Application Publication
(10) Pub. No.: US 2026/0359132 A1
(43) Pub. Date: Nov. 12, 2026

(54) RESOURCE SEARCH METHOD, INFORMATION PROCESSING APPARATUS, AND COMPUTER-READABLE RECORDING MEDIUM

(71) Applicant: Fsas Technologies Inc., Kawasaki-shi (JP)

(72) Inventors: Hiroshi ENDO, Kawasaki (JP); Kazuhiro SUZUKI, Kawasaki (JP); Satoshi KAZAMA, Kawasaki (JP); Makoto HATAIDA, Kawasaki (JP)

(73) Assignee: Fsas Technologies Inc., Kawasaki-shi (JP)

(21) Appl. No.: 19/658,177

(22) Filed: Apr. 24, 2026

(30) Foreign Application Priority Data
May 8, 2025 (JP) 2025-078248

(51) Int. Cl. G06F 9/50

(52) U.S. Cl. CPC G06F 9/5044; G06F 9/5077; G06F 2209/5013; G06F 2209/503

(57) ABSTRACT

A non-transitory computer-readable recording medium stores therein a resource search program that causes a computer to execute a process including receiving order information of a logical server from a user using a computer system including composable disaggregated infrastructure, acquiring unused resource information among resources included in a tenant, selecting one or more combinations of resource candidates from the acquired unused resource information based on the order information, based on a straddling number and a weighting for each type of a virtual switch between the resources, calculating a switch straddling estimated number of the virtual switch of a path connecting the resource candidates in the selected combinations to each other, and determining the combination of the resource candidates that minimizes the switch straddling estimated number as resources to be used corresponding to the order information.

### CROSS-REFERENCE TO RELATED APPLICATION

This application is based upon and claims the benefit of priority of the prior Japanese Patent Application No. 2025-078248, filed on May 8, 2025, the entire contents of which are incorporated herein by reference.

### FIELD

The embodiment discussed herein is related to a resource search program, a resource search method, and an information processing apparatus.

### BACKGROUND

A computer system including Composable Disaggregated Infrastructure (CDI) (hereinafter referred to as a CDI system) can change the configuration of a logical server by deploying or releasing hardware resources (hereinafter referred to as resources) in accordance with a workload.

Related technologies include a virtual machine (VM) placement administration system that is suitable for performing optimal VM placement conforming to the specifications of a physical network in creating VMs in a cloud infrastructure in which a plurality of business systems operate. The related technologies are described, for example, in International Publication Pamphlet No. WO 2017/056238.

### SUMMARY

According to an aspect of the embodiments, a non-transitory computer-readable recording medium stores therein a resource search program that causes a computer to execute a process including: receiving order information of a logical server from a user using a computer system including composable disaggregated infrastructure; acquiring unused resource information among resources included in a tenant; selecting one or more combinations of resource candidates from the acquired unused resource information based on the order information; based on a straddling number and a weighting for each type of a virtual switch between the resources, calculating a switch straddling estimated number of the virtual switch of a path connecting the resource candidates in the selected combinations to each other; and determining the combination of the resource candidates that minimizes the switch straddling estimated number as resources to be used corresponding to the order information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram of an example of a case in which a logical server is generated from a resource pool of an example;

FIG. 2 is a diagram of an example of a hierarchical structure of resources of the example;

FIG. 3 is a block diagram of an example of the configuration of an information processing system of the example;

FIG. 4 is a block diagram of an example of the functional configuration of an information processing apparatus of the example;

FIG. 5 is a diagram of an example of a resource table storage unit;

FIG. 6 is a diagram of an example of a logical server table storage unit;

FIG. 7 is a diagram of an example of an administration table storage unit;

FIG. 8 is a diagram of an example of a straddle number table storage unit;

FIG. 9 is a diagram of an example of a weighting table storage unit;

FIG. 10 is a diagram of an example of a used bus table storage unit;

FIG. 11 is a diagram of an example of a hierarchical structure of virtual switches before generation of a logical server of the example;

FIG. 12 is a diagram of an example of a search for a switch straddling estimated number during generation of the logical server of the example;

FIG. 13 is a diagram of an example of the search for the switch straddling estimated number during generation of the logical server of the example;

FIG. 14 is a diagram of an example of a bus overlapping number during generation of the logical server of the example;

FIG. 15 is a flowchart of an example of monitoring processing of the example;

FIG. 16 is a flowchart of an example of search processing of the example; and

FIG. 17 is a diagram of an example of a computer that executes a resource search program.

### DESCRIPTION OF EMBODIMENTS

However, the related technologies described above allow VMs to be placed on physical machines in conformity with the specifications of the physical network, but it is difficult to configure a logical server by deploying various types of hardware resources with widely different physical distances. Meanwhile, when various types of hardware resources are deployed from a hardware resource pool to form a logical server, the performance of the resources may degrade if the physical distance between the resources is large. Even between resources that are physically close to each other, the performance of the resources may degrade due to differences in switch performance. Thus, for example, when a user generates a logical server, the user wants to select resources such that the performance of the resources does not degrade, but it may be difficult for the user to determine which resources to select.

One aspect is to provide a resource search program, a resource search method, and an information processing apparatus that can search for optimal resources from a resource pool of a CDI system.

Preferred embodiments will be explained with reference to accompanying drawings. The following describes examples of a resource search program, a resource search method, and an information processing apparatus disclosed in the present application in detail based on the accompanying drawings. Note that the following examples do not limit the disclosed technology. The following examples may be combined as appropriate to the extent that they are not contradictory.

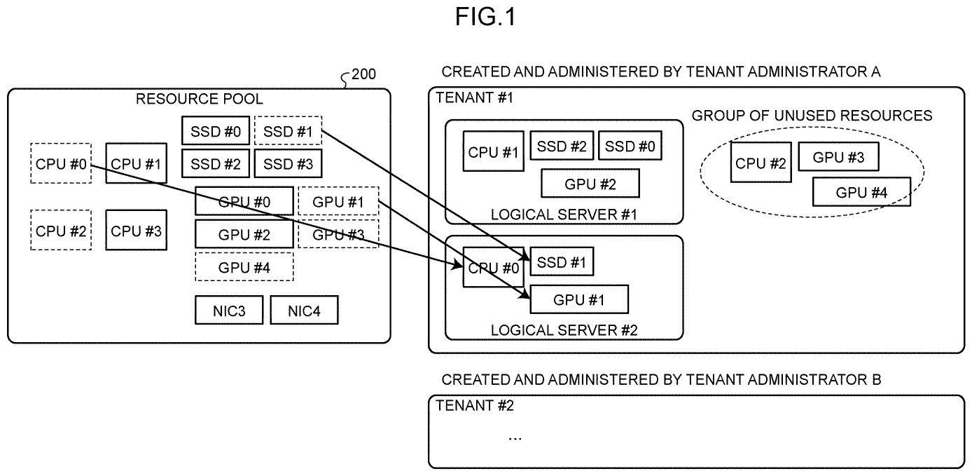

FIG. 1 is a diagram of an example of a case in which a logical server is generated from a resource pool of an example. As illustrated in FIG. 1, various types of hardware resources are prepared in a resource pool 200. Note that the present example is a resource search technology for a CDI system. Tenant administrators A and B of the CDI system, who are users, create and administer the logical server in accordance with order information, from a group of unused resources within the resource pool 200 included in tenants #1 and #2 of their own respective CDI systems. The tenant is a group unit used in the CDI system, and a tenant administrator can reserve resources to the tenant for the purpose of preventing users from scrambling for resources from the resource pool. The reserved resources can be freely used by the administrator (user) belonging to the tenant, and the user can generate the logical server from among these reserved resources. Note that the resources are, for example, one or more types of resources out of a central processing unit (CPU), a graphics processing unit (GPU), and a solid state drive (SSD). In the example in FIG. 1, when the tenant administrator A newly creates a logical server #2, CPU #0, GPU #1, and SSD #1 are selected and secured. In other words, the tenant administrator A creates the logical server in accordance with the order information, from the group of unused resources within the resource pool 200. The tenant administrator A may also add resources to the existing logical server from a group of unused resources included in his/her own tenant #1. Note that the resource pool 200 is also called a fabric pool.

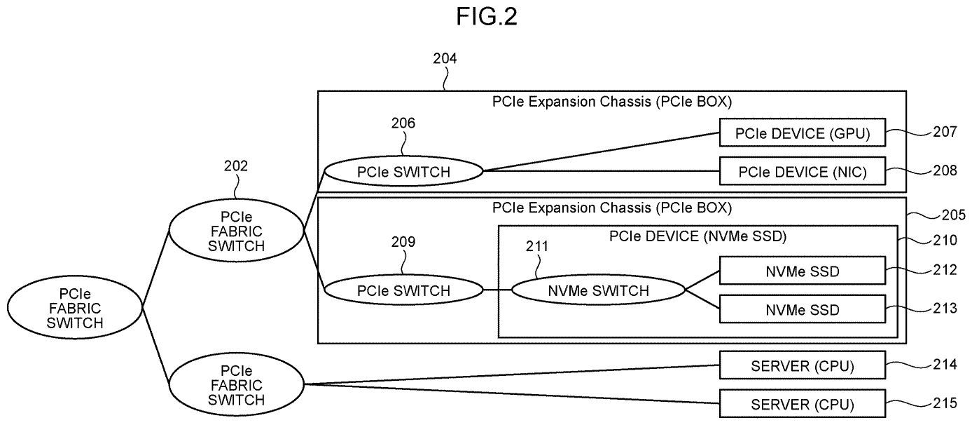

FIG. 2 is a diagram of an example of a hierarchical structure of resources of the example. As illustrated in FIG. 2, the resources included in the resource pool 200 are connected to each other with buses to form a hierarchical structure via a virtual switch. Examples of the type of the virtual switch include a PCIe switch, a PCIe fabric switch, and an NVMe switch. PCIe switches 206 and 209 of PCIe boxes 204 and 205, respectively, are connected to a PCIe fabric switch 202. PCIe devices 207, 208, which are resources, are connected to the PCIe switch 206. The PCIe device 207 is, for example, a GPU. The PCIe device 208 is, for example, a network interface card (NIC).

An NVMe switch 211 within a PCIe device 210 is connected to the PCIe switch 209. The PCIe device 210 includes the NVMe switch 211 and NVMe SSDs 212 and 213, which are resources. The NVMe SSDs 212 and 213 are connected to the NVMe switch 211. The NVMe switch 211 is a switch within the device, and is, for example, a switch that branches to the NVMe SSDs 212 and 213 that reside on a single PCIe device.

Servers 214 and 215, which are resources, are connected to a PCIe fabric switch. The servers 214 and 215 are, for example, CPUs. The PCIe fabric switch, the PCIe switches 206 and 209, and the NVMe switch 211 are examples of various types of virtual switches with widely varying physical distances. The PCIe fabric switch 202, the PCIe switches 206, 209, and the NVMe switch 211 can be controlled to generate the logical server in accordance with the order information, from the group of unused resources within the resource pool 200. In other words, the present example is a different configuration from distributed computing performed by network switches. Note that as more virtual switches are straddled, a farther physical distance is given.

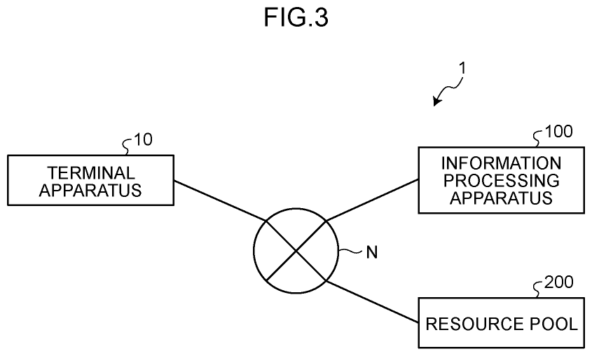

FIG. 3 is a block diagram of an example of the configuration of an information processing system of the example. As illustrated in FIG. 3, this information processing system 1 has a terminal apparatus 10, an information processing apparatus 100, and the resource pool 200.

The terminal apparatus 10, the information processing apparatus 100, and the resource pool 200 are connected to each other in a mutually communicable manner via a network N. The information processing apparatus 100 and the resource pool 200 are connected to each other in a mutually communicable manner via the network N. For such a network N, any type of communication network can be employed, whether wired or wireless, including the Internet, a local area network (LAN), and a virtual private network (VPN). The communication via the network N may be encrypted by, for example, Transport Layer Security (TLS)/Secure Sockets Layer (SSL) or the like.

The information processing system 1 is an example of a system in which the administrator belonging to the tenant can generate the logical server from the group of resources within the resource pool 200 included in the tenant and provide various services by giving instructions to the information processing apparatus 100 via the terminal apparatus 10. Note that in the following description, the administrator may be represented as a user.

The terminal apparatus 10 is an information processing apparatus operated by the administrator (user) belonging to the tenant. For the terminal apparatus 10, for example, a personal computer (PC) can be used. The terminal apparatus 10 transmits the order information of the logical server to the information processing apparatus 100. The terminal apparatus 10 can access administration information and the like of the logical server in the information processing apparatus 100.

The information processing apparatus 100 administers the resources within the resource pool 200 and administers the logical server for each tenant. For example, upon receiving the order information of the logical server from the terminal apparatus 10, the information processing apparatus 100 searches for resources corresponding to the order information from the group of resources within the resource pool 200 included in the tenant to which the user of the terminal apparatus 10 belongs. Based on a search result, the information processing apparatus 100 generates the logical server by controlling the PCIe fabric switch 202, the PCIe switches 206 and 209, and the NVMe switch 211. Note that in FIG. 3, the information processing apparatus 100 and the resource pool 200 are described as separate entities, but they may be integrated. The information processing apparatus 100 may also provide Application Programming Interface (API) that administers the logical server and the resources within the resource pool 200 to the terminal apparatus 10. In other words, the information processing apparatus 100 may include CDI administration software.

As illustrated in FIG. 1 and FIG. 2, the resource pool 200 has various types of resources. The resource pool 200 has, for example, resources such as CPUs, GPUs, and SSDs and virtual switches that connect the resources to each other in a hierarchical structure.

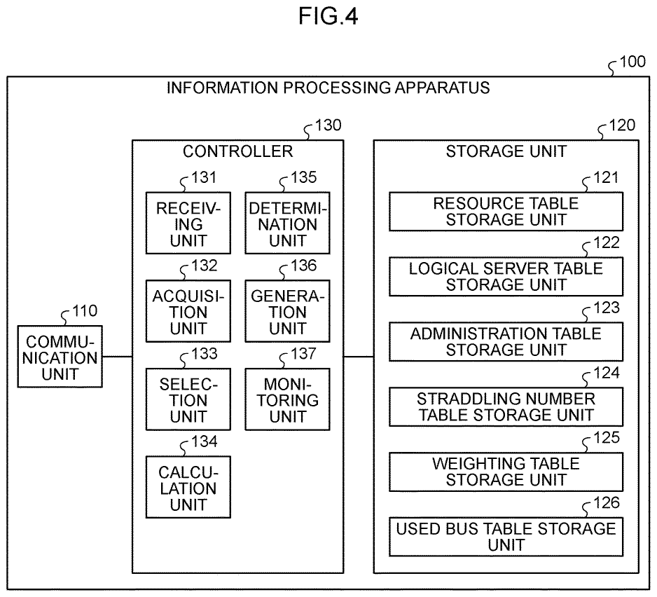

Next, the configuration of the information processing apparatus 100 will be described. FIG. 4 is a block diagram of an example of the functional configuration of the information processing apparatus of the example. As illustrated in FIG. 4, the information processing apparatus 100 has a communication unit 110, a storage unit 120, and a controller 130. Note that the information processing apparatus 100 may also have various functional units that known computers have, for example, functional units such as various input devices and voice output devices apart from the functional units illustrated in FIG. 4.

The communication unit 110 is implemented by, for example, an NIC or the like. The communication unit 110 is a communication interface that is connected to the terminal apparatus 10 and the resource pool 200 in a wired or wireless manner via the network N and is responsible for communication of information with the terminal apparatus 10 and the resource pool 200. The communication unit 110 receives the order information and the administration information of the logical server from the terminal apparatus 10 via the network N. The communication unit 110 outputs the received order information of the logical server to the controller 130. The communication unit 110 transmits the administration information of the logical server input from the controller 130 to the terminal apparatus 10 via the network N. The communication unit 110 transmits resource control information input from the controller 130 to the resource pool 200 via the network N. The communication unit 110 outputs the resource control information from the resource pool 200 to the controller 130 via the network N. In other words, the communication unit 110 transmits and receives the resource control information between the controller 130 and the resource pool 200.

The storage unit 120 is implemented by, for example, a semiconductor memory element such as a random access memory (RAN) or a flash memory or a storage such as a hard disk or an optical disc. The storage unit 120 has a resource table storage unit 121, a logical server table storage unit 122, an administration table storage unit 123, a straddling number table storage unit 124, a weighting table storage unit 125, and a used bus table storage unit 126. The storage unit 120 also stores therein information for use in processing in the controller 130.

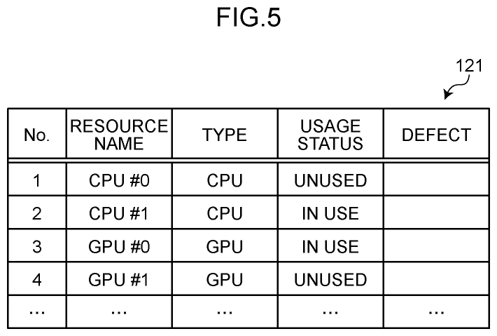

The resource table storage unit 121 stores therein a resource table indicating the usage status and the like of each resource in the resource pool 200. FIG. 5 is a diagram of an example of the resource table storage unit. As illustrated in FIG. 5, the resource table storage unit 121 has items such as “No.”, “resource name”, “type”, “usage status”, and “defect”. “No.” is an identifier identifying each resource included in the resource pool 200. “Resource name” is a name unique to each resource. For example, for a CPU, the serial number of the CPU is represented by # and a number, which is represented in a format such as “CPU #0”. “Type” is information indicating the type of the resource. Examples of the type of the resource include CPU, GPU, SSD, and NIC. GPU or the like with different processing capabilities may be an identifiable type. “Usage status” is information indicating whether the resource is being used by the logical server. “Defect” is information indicating whether the resource is defect. “Defect” can be left blank if it is normal and represented as “1” if it is defect, for example.

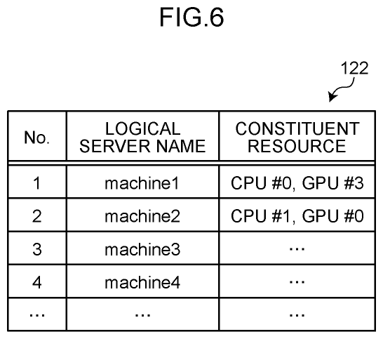

Referring back to the description of FIG. 4, the logical server table storage unit 122 stores therein a logical server table indicating the name of the logical server and its constituent resources. FIG. 6 is a diagram of an example of the logical server table storage unit. As illustrated in FIG. 6, the logical server table storage unit 122 has items such as “No.”, “logical server name”, and “constituent resource”. “No.” is an identifier identifying the logical server. “Logical server name” is the name of the logical server. “Constituent resource” lists the resource names of the resources constituting each logical server. The example in FIG. 6 indicates that the logical server name “machine 1” includes CPU #0 and GPU #3.

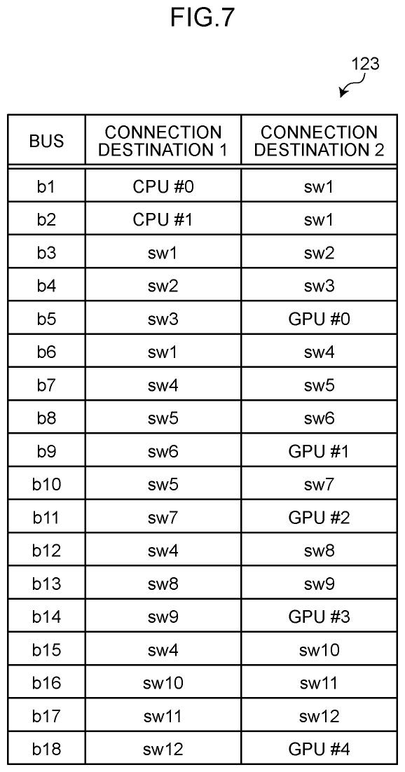

Referring back to the description of FIG. 4, the administration table storage unit 123 stores therein an administration table that administers the hierarchical structure of the resources. FIG. 7 is a diagram of an example of the administration table storage unit. As illustrated in FIG. 7, the administration table storage unit 123 has items such as “bus”, “connection destination 1”, and “connection destination 2”. “Bus” is an identifier identifying the bus connecting each resource and the virtual switch to each other or the virtual switch and the virtual switch to each other in the hierarchical structure of the resources. In the example in FIG. 7, the bus is represented as “b1” to “b18”. “Connection destination 1” is information indicating the resource as one connection destination of the bus. “Connection destination 2” is information indicating the resource as the other connection destination of the bus. In “connection destination 1” and “connection destination 2”, the virtual switch is represented as “sw1” to “sw12”. For example, bus “b1” indicates that CPU #0 and virtual switch sw1 are connected to each other.

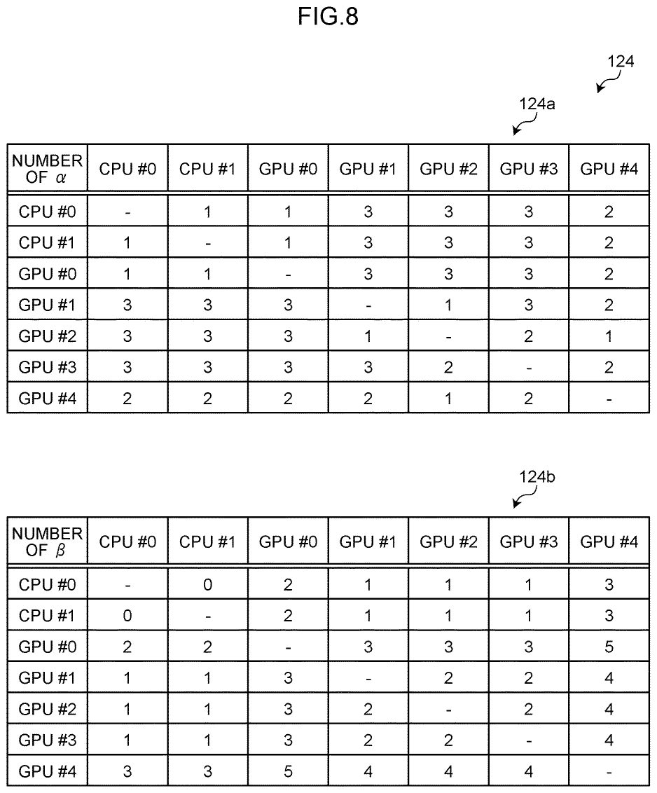

Referring back to the description of FIG. 4, the straddling number table storage unit 124 stores therein a straddling number table indicating the number of virtual switches straddling the resources for each switch type. FIG. 8 is a diagram of an example of the straddle number table storage unit. As illustrated in FIG. 8, for example, when there are two types of virtual switches, or switch type α and β, the straddling number table storage unit 124 has a straddling number table 124a for switch type α and a straddling number table 124b for switch type β. The straddling number table 124a lists connectable resources in items in a row direction and items in a column direction, and represents the straddling number of switch type α between resources on a round-robin system (“NUMBER OF α” in FIG. 8). Similarly, the straddling number table 124b lists connectable resources in items in a row direction and items in a column direction, and represents the straddling number of switch type β between resources on a round-robin system (“NUMBER OF β” in FIG. 8). For example, it can be seen that three switch type α and one switch type β are straddled between CPU #0 and GPU #3. Note that the straddling number table storage unit 124 is generated and updated based on the administration table storage unit 123.

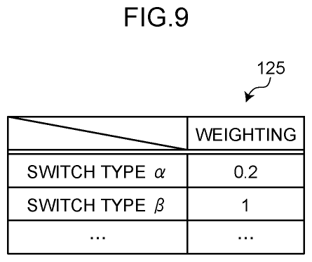

Referring back to the description of FIG. 4, the weighting table storage unit 125 stores therein a weighting table indicating a weighting parameter with a physical form (connection distance) normalized for each switch type of the virtual switch. FIG. 9 is a diagram of an example of the weighting table storage unit. As illustrated in FIG. 9, the weighting table storage unit 125 associates a weighting with each switch type of the virtual switch. The weighting is a parameter normalizing the physical form; as the physical connection distance is closer, the value of the weighting becomes smaller. In the example in FIG. 9, the value of the weighting for switch type α is “0.2”, which is smaller than “1”, which is the value of the weighting for switch type β, thus indicating that the physical connection distance is closer for switch type α than for switch type β. The value of the weighting may further reflect the performance of the virtual switch. Note that the weighting table storage unit 125 is set in advance.

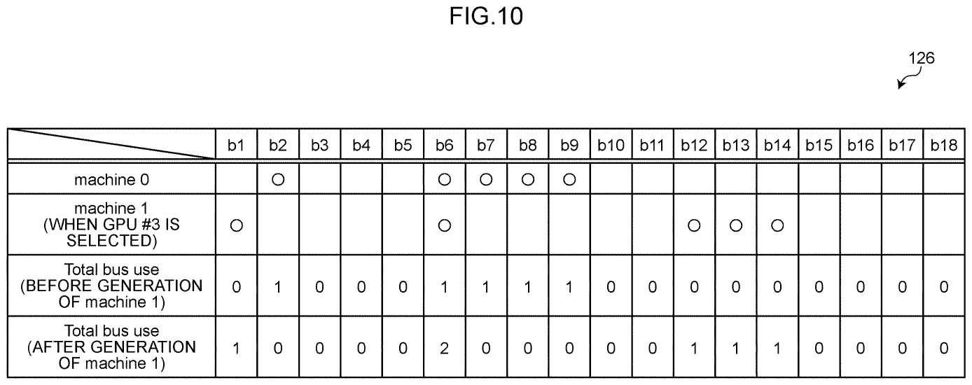

Referring back to the description of FIG. 4, the used bus table storage unit 126 stores therein used buses between all resources within each logical server, and also stores therein a used bus table indicating the number of each bus used before and after generation when a new logical server is generated. FIG. 10 is a diagram of an example of the used bus table storage unit. As illustrated in FIG. 10, in the used bus table storage unit 126, for example, for each bus “b1” to “b18”, a used bus by a logical server “machine 0”, and a bus that “machine 1” is scheduled to use are circled. Note that “machine 0” includes CPU #1 and GPU #1 in a hierarchical structure 220 described below. “Machine 1” is a configuration when CPU #0 and GPU #3 are selected in the hierarchical structure 220 described below. “TOTAL BUS USE (BEFORE GENERATION OF machine 1)” in the bus table storage unit 126 represents the number of each bus used before generation of “machine 1”. In the example in FIG. 10, “TOTAL BUS USE (BEFORE GENERATION OF machine 1)” is “1” for the buses “b2” and “b6” to “b9”, and “0” for the other buses. “TOTAL BUS USE (AFTER GENERATION OF machine 1)” in the used bus table storage unit 126 represents the number of each bus used viewed from “machine 1” after generation of “machine 1”. In the example in FIG. 10, “TOTAL BUS USE (AFTER GENERATION OF machine 1)” is “1” for the buses “b1” and “b12” to “b14”, “2” for “b6”, and “0” for the other buses. In other words, the table indicates that when “machine 1” is generated, the bus “b6” interferes with “machine 0”.

Referring back to the description of FIG. 4, the controller 130 is implemented by, for example, computer programs stored in an internal storage being executed by a CPU, a micro processing unit (MPU), or the like with a RAM as a working area. The controller 130 may be implemented by, for example, an integrated circuit such as an application specific integrated circuit (ASIC) or a field programmable gate array (FPGA).

The controller 130 has a receiving unit 131, an acquisition unit 132, a selection unit 133, a calculation unit 134, a determination unit 135, a generation unit 136, and a monitoring unit 137, and implements or executes the functions and actions of information processing described below. Note that the internal configuration of the controller 130 is not limited to the configuration illustrated in FIG. 4, but may be another configuration as long as it is configured to perform the information processing described below.

The receiving unit 131 receives the order information of the logical server from the administrator as the user belonging to the tenant. The order information includes specification conditions desired by the logical server. Examples of the specification conditions include, for the GPU, model number and the capacity of a video random access memory (VRAM). Examples of the specification conditions include, for the SSD, storage capacity. The receiving unit 131 outputs the received order information to the selection unit 133. The receiving unit 131 outputs an acquisition instruction to the acquisition unit 132.

Upon input of the acquisition instruction from the receiving unit 131, the acquisition unit 132 refers to the resource table storage unit 121 to acquire unused resource information assigned to the tenant of the user. In other words, the acquisition unit 132 acquires the unused resource information among the resources included in the tenant of the user. The acquisition unit 132 outputs the acquired unused resource information to the selection unit 133.

The selection unit 133 receives input of the order information from the receiving unit 131 and receives input of the unused resource information from the acquisition unit 132. The selection unit 133 selects one or more combinations of resource candidates from the unused resource information based on the input order information. In other words, the selection unit 133 selects one or more combinations of resource candidates from the unused resource information for resources corresponding to the specification conditions of the order information.

The selection unit 133, for example, numbers unused CPU resources and GPU resources in the unused resource information with i and j, respectively. Note that i and j are counters for the unused CPU resources and GPU resources, respectively, and the maximum number of unused resources for each is an upper limit. The selection unit 133 sets i=0 and j=0 to initialize the counters.

The selection unit 133 selects an ith CPU resource. Next, the selection unit 133 selects a jth GPU resource. The selection unit 133 outputs combination information indicating a combination of the ith CPU resource and the jth GPU resource that have been selected to the calculation unit 134.

Upon input of the combination information from the selection unit 133, the calculation unit 134 refers to the straddling number table storage unit 124 to acquire a straddling number for each type of the virtual switch in a path between the ith CPU resource and the jth GPU resource included in the combination information. The calculation unit 134 refers to the weighting table storage unit 125 to acquire a weighting for each type of the virtual switch in the path. The calculation unit 134 calculates a switch straddling estimated number of the path in the selected combination based on the straddling number and the weighting for each type of the virtual switch that have been acquired. The calculation unit 134, for example, calculates the switch straddling estimated number using Expression (1) below. The calculation unit 134 outputs the combination information and the calculated switch straddling estimated number to the determination unit 135.

$$( \begin{matrix}SWITCH STRADDLING \\ ESTIMATED NUMBER\end{matrix} ) = {\sum }^{n} \{ ( \begin{matrix}STRADDLING NUMBER OF \\ nth SWITCH TYPE\end{matrix} ) \times ( WEIGHTING VALUE OF nth SWITCH TYPE ) \} \qquad ( 1 )$$

Here, n corresponds to the number of the type of the virtual switch, and, for example, when there are two types, or switch type α and β, n=2. In other words, as shown in Expression (1) above, the calculation unit 134 adds a value obtained by multiplying the straddling number by the weighting by the number of the type of the virtual switch for each type of the virtual switch to calculate the switch straddling estimated number.

In other words, the calculation unit 134 calculates the switch straddling estimated number of the virtual switch of a path connecting the resource candidates to each other in the selected combination based on the straddling number and the weighting for each type of the virtual switch between the resources.

Upon input of the combination information and the switch straddling estimated number from the calculation unit 134, the determination unit 135 determines whether the switch straddling estimated number is the minimum. If the determination unit 135 determines that the switch straddling estimated number is not the minimum, the determination unit 135 does not set the combination of the ith CPU resource and the jth GPU resource included in the combination information as a combination candidate. If the determination unit 135 determines that the switch straddling estimated number is the minimum, the determination unit 135 determines whether there is already a switch straddling estimated number of the same value.

If the determination unit 135 determines that there is no switch straddling estimated number of the same value, the determination unit 135 sets the combination of the ith CPU resource and the jth GPU resource included in the combination information as a tentative combination. Note that at the first determination (i=0, j=0), the determination unit 135 determines a combination to be determined as the tentative combination (the resource candidates). Note that the determination unit 135 temporarily stores the combination information of the tentative combination in the storage unit 120.

If the determination unit 135 determines that there is already a switch straddling estimated number of the same value, the determination unit 135 refers to the used bus table storage unit 126 to acquire the usage status of buses used by other logical servers. The determination unit 135 refers to the used bus table storage unit 126 to acquire the usage status of buses of a combination of the CPU resource and the GPU resource with the switch straddling estimated number of the same value (the existing tentative combination). The determination unit 135 counts a bus interfering number based on the usage status of the buses used by the other logical servers and the usage status of the buses of the existing tentative combination. The determination unit 135 also counts a bus interfering number based on the usage status of the buses used by the other logical servers and the usage status of the buses of the combination of the ith CPU resource and the jth GPU resource included in the combination information (a current combination).

The determination unit 135 compares the bus interfering number of the existing tentative combination with the bus interfering number of the current combination to determine whether the bus interfering number of the current combination is less than the bus interfering number of the tentative combination. In other words, the determination unit 135 determines whether the current combination has a fewer bus interfering number. If the determination unit 135 determines that the bus interfering number of the current combination is less than the bus interfering number of the tentative combination, the determination unit 135 sets the current combination as the tentative combination. If the determination unit 135 determines that the bus interfering number of the current combination is not less than the bus interfering number of the tentative combination, the determination unit 135 sets the existing tentative combination continuously as the tentative combination.

Upon completion of the determination of the switch straddling estimated number and the bus interfering number for the combination of the ith CPU resource and the jth GPU resource included in the combination information, the determination unit 135 determines whether there is a (j+1)th GPU resource. If the determination unit 135 determines that there is a (j+1)th GPU resource, the determination unit 135 increments j and instructs the selection unit 133 to select the next combination and repeat the determination of the switch straddling estimated number and the bus interfering number. If the determination unit 135 determines that there is no (j+1)th GPU resource, the determination unit 135 determines whether there is an (i+1)th CPU resource. If the determination unit 135 determines that there is an (i+1)th CPU resource, the determination unit 135 increments i and instructs the selection unit 133 to select the next combination and repeat the determination of the switch straddling estimated number and the bus interfering number.

If the determination unit 135 determines that there is no (i+1)th CPU resource, the determination unit 135 determines the CPU resource and the GPU resource of the tentative combination as the resources to be used corresponding to the order information. The determination unit 135 outputs information on the determined resources to be used to the generation unit 136. Note that the information on the resources to be used is an example of a converted order form, which describes specific resources within the resource pool 200. Apart from the optimization using repeated computation described above, the determination unit 135 may also use other search methods such as graph database (DB).

In other words, when there are a plurality of the combinations that minimize the switch straddling estimated number, the determination unit 135, based on the usage status of the buses on the path, determines the number of the buses used by the other logical servers and included in the path for each combination. In addition, the determination unit 135 determines the combination of the resource candidates with the number included in the path being fewer as the resources to be used. In other words, the determination unit 135 determines the combination of the resource candidates that minimizes the switch straddling estimated number as the resources to be used corresponding to the order information.

Upon input of the information on the resources to be used from the determination unit 135, the generation unit 136 transmits and receives the resource control information to and from the resource pool 200 so that the logical server is generated from the group of resources within the resource pool 200 based on the information on the resources to be used. In other words, the generation unit 136 generates the logical server based on the determined resources to be used. The generation unit 136 stores information on the generated logical server in the resource table storage unit 121, the logical server table storage unit 122, and the used bus table storage unit 126.

The monitoring unit 137 monitors the group of resources within the resource pool 200. The monitoring unit 137, for example, starts monitoring the group of resources within the resource pool 200 at a certain cycle (about one day to one week). The monitoring unit 137 makes a comparison with the previous check result to determine whether there are any defect resources. If the monitoring unit 137 determines that there is a defect resource, the monitoring unit 137 deletes information on the defect resource from the administration table storage unit 123. The monitoring unit 137 also updates the resource table storage unit 121, the straddling number table storage unit 124, and the used bus table storage unit 126 to delete the information on the defect resource.

If the monitoring unit 137 determines that there are no defect resources, the monitoring unit 137 makes a comparison with the previous check result to determine whether there are any increases or decreases in resources. If the monitoring unit 137 determines that there is an increase or decrease in a resource, the monitoring unit 137 adds or deletes information on the increased or decreased resource to or from the administration table storage unit 123. The monitoring unit 137 also updates the resource table storage unit 121, the straddling number storage unit 124, and the used bus table storage unit 126 to add or delete the information on the increased or decreased resource. If the monitoring unit 137 determines that there are no increases or decreases in resources, the monitoring unit 137 ends the monitoring processing. In other words, the monitoring unit 137 monitors the resources and, when there is a defect resource, an increased resource, or a decreased resource, updates the information on the resources. Note that the increase and the decrease in resources here represent, for example, attaching and detaching hardware resources such as SSD cards (the NVMe SSDs 212 and 213) and GPU cards (the PCIe device 207) to and from the PCIe boxes 204 and 205.

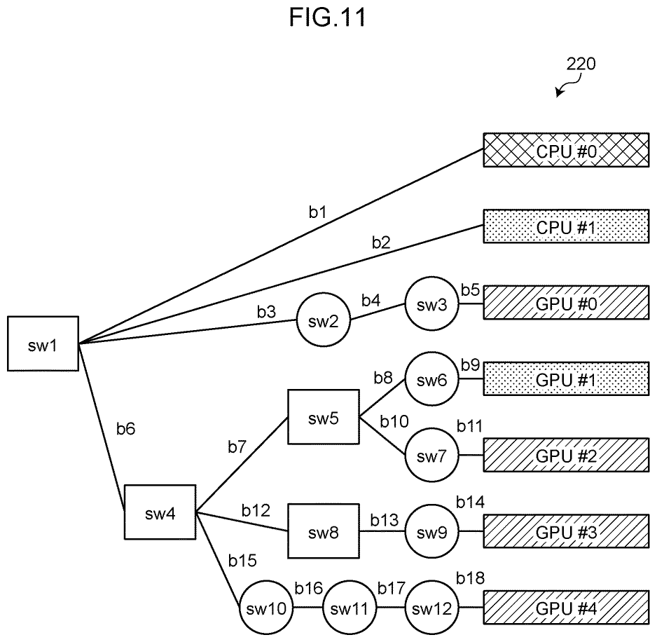

Next, an example of search processing will be described using FIG. 11 to FIG. 14. FIG. 11 is a diagram of an example of a hierarchical structure of virtual switches before generation of the logical server of the example. The hierarchical structure 220 illustrated in FIG. 11 has CPU #0 and #1 and GPU #0 to #4 as resources, and the resources are connected to each other through the virtual switches sw1 to sw12 and the buses b1 to b18. The connection between each resource and each virtual switch is the connection represented by the administration table storage unit 123 illustrated in FIG. 7. In FIG. 11, the virtual switches sw1, sw4, sw5, and sw8, which are represented by rectangles, are switch type α, and the virtual switches sw2, sw3, sw6, sw7, and sw9 to sw12, which are represented by circles, are switch type β.

In the hierarchical structure 220, assume that CPU #1 and GPU #1 are already assigned to logical server #0 and that CPU #0, GPU #0, and GPU #2 to GPU #4 are unused resources. Now consider search for resources when logical server #1 including one CPU resource and one GPU resource as the order information is generated.

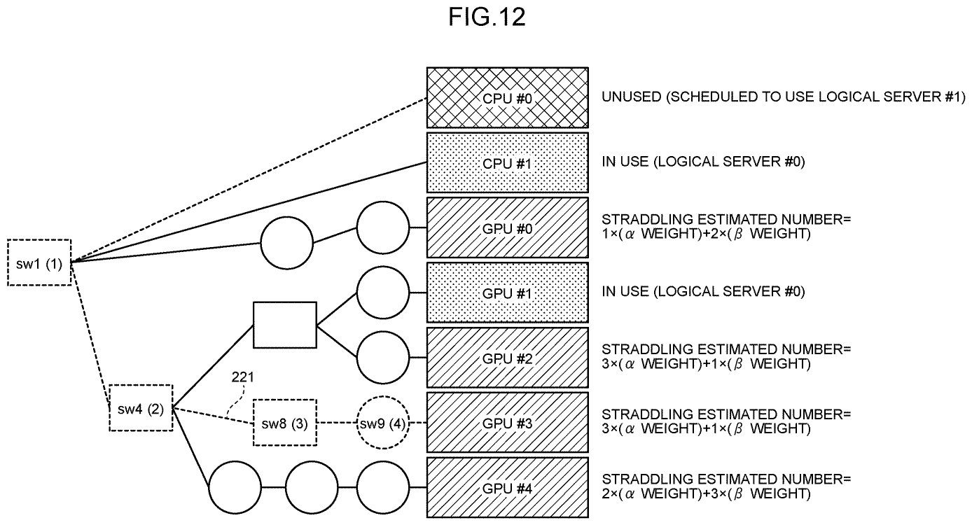

FIG. 12 is a diagram of an example of a search for the switch straddling estimated number during generation of the logical server of the example. As illustrated in FIG. 12, the selection unit 133 selects for each combination of CPU #0 and GPU #0, and GPU #2 to GPU #4. The calculation unit 134 calculates the switch straddling estimated number for each combination. For example, in the combination of CPU #0 and GPU #3, the calculation unit 134 calculates the switch straddling estimated number for a path 221 indicated by the dotted line, which straddles four virtual switches, or the virtual switches sw1, sw4, sw8, and sw9, in the hierarchical structure 220. Note that the straddling number of virtual switches from CPU #0 is three for GPU #0, four for GPU #2, and five for GPU #4. Here, based on a method of looking only at the straddling number of virtual switches, GPU #0, which minimizes the straddling number, will be selected.

Since the path 221 has three switch type α and one switch type β, the calculation unit 134 refers to the weighting table storage unit 125 to acquire a weighting value of “0.2” for switch type α and a weighting value of “1” for switch type 3. Note that, for example, switch type α is a network switch and switch type R is a PCIe switch. The calculation unit 134 calculates the switch straddling estimated number as “1.6” based on Expression (1) above. Similarly, the calculation unit 134 also calculates the switch straddling estimated number for each combination of CPU #0 and GPU #0, GPU #2, or GPU #4.

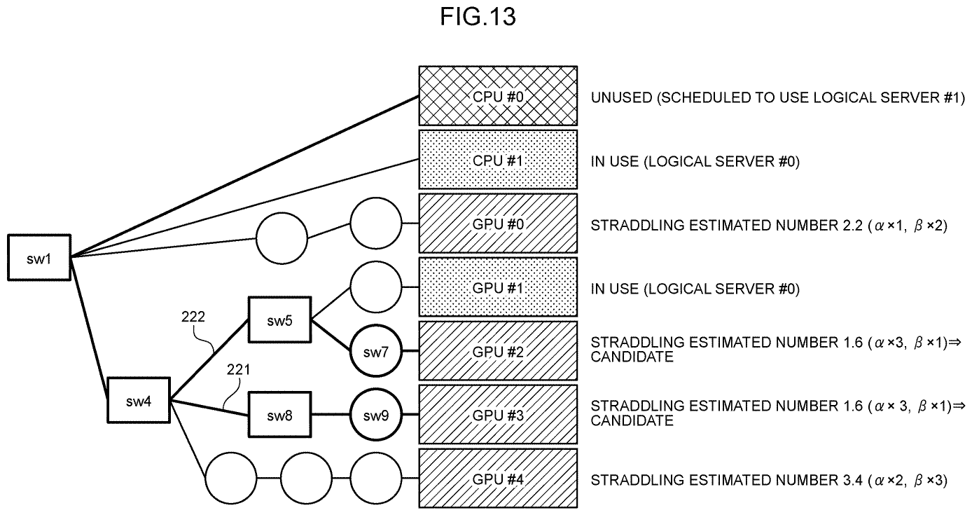

FIG. 13 is a diagram of an example of the search for the switch straddling estimated number during generation of the logical server of the example. As illustrated in FIG. 13, among the combinations of the switch straddling estimated numbers, the combination of CPU #0 and GPU #2 and the combination of CPU #0 and GPU #3 have a switch straddling estimated number of “1.6”, which is the same value and the minimum. The switch straddling estimated number is “2.2” for the combination of CPU #0 and GPU #0 and “3.4” for the combination of CPU #0 and GPU #4. If the straddling number of virtual switches is simply looked at, the combination of CPU #0 and GPU #0 will be selected, but in the present example, the switch type is taken into account. Therefore, the determination unit 135 sets two combinations, or the combination of CPU #0 and GPU #2 and the combination of CPU #0 and GPU #3, as candidates. Note that the combination of CPU #0 and GPU #2 is a path 222 straddling four virtual switches, or the virtual switches sw1, sw4, sw5, and sw7.

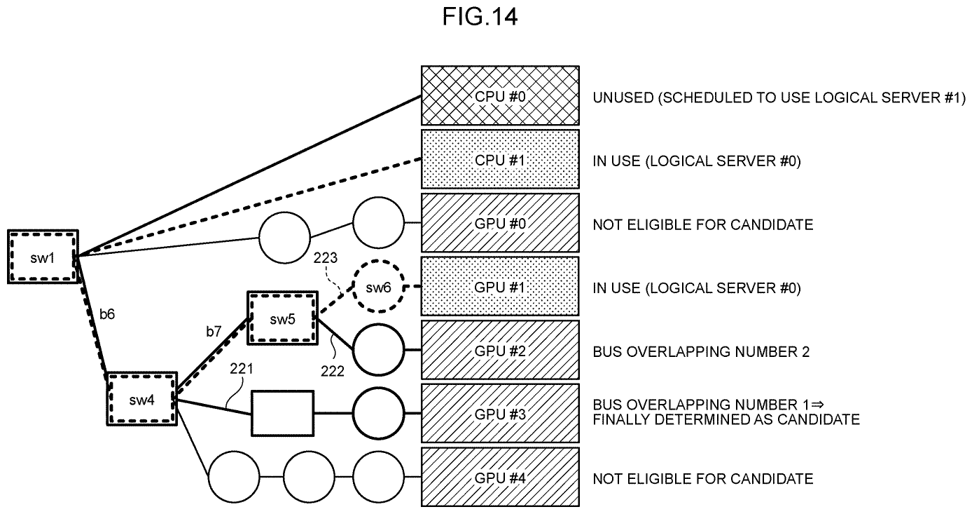

FIG. 14 is a diagram of an example of a bus overlapping number during generation of the logical server of the example. As illustrated in FIG. 14, the determination unit 135 acquires the usage status of the buses used by logical server #0 because there are switch straddling estimated numbers having the same value. Logical server #0 is a path 223 straddling four virtual switches, or the virtual switches sw1, sw4, sw5, and sw6, and thus uses the buses b2, b6, b7, b8, and b9 (refer to FIG. 10 and FIG. 11). On the other hand, the combination of CPU #0 and GPU #2 uses the buses b1, b6, b7, b10, and b11 (refer to FIG. 11). In the combination of CPU #0 and GPU #2, when the values of the buses b1 to b18 of “TOTAL BUS USE (AFTER GENERATION OF machine 1)” in FIG. 10 are calculated if the combination is selected, the buses b1, b10, and b11 are “1”, the buses b6 and b7 are “2”, and the others are “0” (not illustrated in FIG. 10). The total value of the values of the buses b1 to b18 of “TOTAL BUS USE (AFTER GENERATION OF machine 1)” if the combination of CPU #0 and GPU #2 is selected is “7”. In other words, the bus overlapping number is “2” because the buses b6 and b7 overlap. The combination of CPU #0 and GPU #3 uses the buses b1, b6, b12, b13, and b14 (refer to FIG. 10 and FIG. 11). In the combination of CPU #0 and GPU #3, when the values of the buses b1 to b18 of “TOTAL BUS USE (AFTER GENERATION OF machine 1)” in FIG. 10 are calculated if the combination is selected, the buses b1 and b12 to b14 are “1”, the bus b6 is “2”, and the others are “0” (corresponding to the example in FIG. 10). The total value of the values of the buses b1 to b18 of “TOTAL BUS USE (AFTER GENERATION OF machine 1)” if the combination of CPU #0 and GPU #3 is selected is “6”. In other words, the bus overlapping number is “1” because the bus b6 overlaps.

The determination unit 135 compares the used buses of logical server #0 with the used buses of the combination of CPU #0 and GPU #2 and the combination of CPU #0 and GPU #3, and counts the bus interfering number. The bus interfering number is, for example, the total value of the values of the buses b1 to b18 of “TOTAL BUS USE (AFTER GENERATION OF machine 1)” described above. In the calculation example described above, the bus interfering number is “7” for the combination of CPU #0 and GPU #2, and “6” for the combination of CPU #0 and GPU #3. Therefore, the determination unit 135 determines the combination of CPU #0 and GPU #3, which has a fewer bus interfering number, as the resources to be used corresponding to the order information. Note that the determination unit 135 may compare the bus overlapping number instead of the bus interfering number. By thus performing the search processing, optimal resources can be searched for from the resource pool 200. After that, the generation unit 136 generates logical server #1 with the combination of CPU #0 and GPU #3 within the resource pool 200.

Note that when a new logical server uses a plurality of GPU resources, the determination unit 135 may select the GPU resource with a close physical distance. The determination unit 135 may also determine the resources to be used by prioritizing a combination of paths having a fewer bus interfering number with the other logical servers over the switch straddling estimated number.

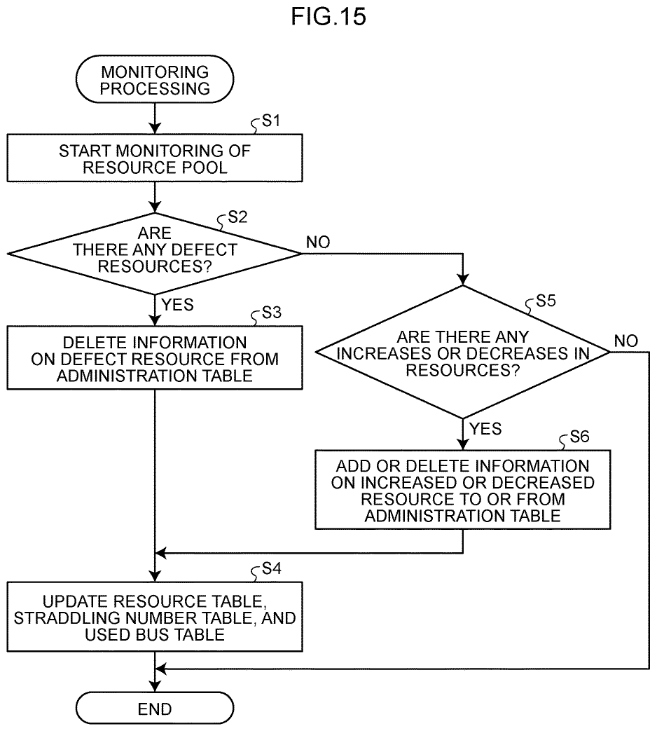

Next, the operation of the information processing apparatus 100 of the example will be described. First, resource monitoring processing will be described using FIG. 15. FIG. 15 is a flowchart of an example of monitoring processing of the example.

The monitoring unit 137 starts monitoring of the resource pool 200 (Step S1). The monitoring unit 137 determines whether there are any defect resources (Step S2). If the monitoring unit 137 determines that there is a defect resource (Yes at Step S2), the monitoring unit 137 deletes information on the defect resource from the administration table storage unit 123 (Step S3). The monitoring unit 137 updates the resource table storage unit 121, the straddling number storage unit 124, and the used bus table storage unit 126 to delete the information on the defect resource (Step S4), and ends the monitoring processing.

On the other hand, if the monitoring unit 137 determines that there are no defect resources (No at Step S2), the monitoring unit 137 determines whether there are any increases or decreases in resources (Step S5). If the monitoring unit 137 determines that there is an increase or decrease in a resource (Yes at Step S5), the monitoring unit 137 adds or deletes information on the increased or decreased resource to or from the administration table storage unit 123 (Step S6). The monitoring unit 137 updates the resource table storage unit 121, the straddling number storage unit 124, and the used bus table storage unit 126 to add or delete the information on the increased or decreased resource (Step S4), and ends the monitoring processing. If the monitoring unit 137 determines that there are no increases or decreases in resources (No at Step S5), the monitoring unit 137 ends the monitoring processing. As a result, the information processing apparatus 100 can reflect the defect, increased, or decreased resources in the resource table storage unit 121, the administration table storage unit 123, the straddling number storage unit 124, and the used bus table storage unit 126.

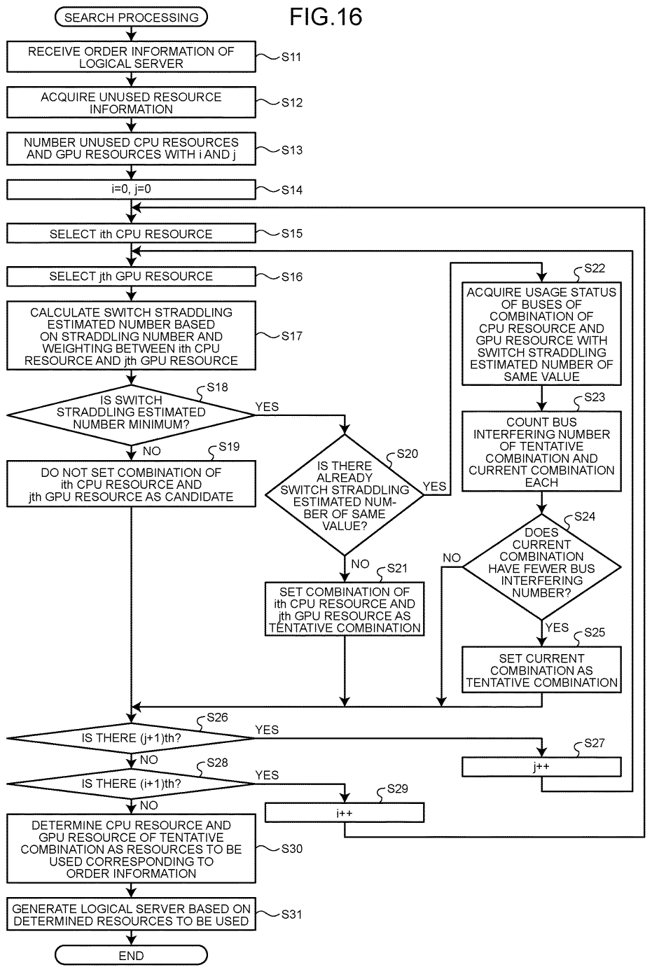

Next, search processing when the logical server is generated will be described using FIG. 16. FIG. 16 is a flowchart of an example of search processing of the example.

The receiving unit 131 receives the order information of the logical server from the administrator as the user belonging to the tenant (Step S11). The receiving unit 131 outputs the received order information to the selection unit 133. The receiving unit 131 outputs an acquisition instruction to the acquisition unit 132.

Upon input of the acquisition instruction from the receiving unit 131, the acquisition unit 132 refers to the resource table storage unit 121 to acquire unused resource information (Step S12). The acquisition unit 132 outputs the acquired unused resource information to the selection unit 133.

Upon input of the unused resource information from the acquisition unit 132, the selection unit 133 numbers unused CPU resources and GPU resources with i and j, respectively (Step S13). The selection unit 133 sets i=0 and j=0 to initialize the counters (Step S14).

The selection unit 133 selects an ith CPU resource (Step S15). Next, the selection unit 133 selects a jth GPU resource (Step S16). The selection unit 133 outputs combination information indicating a combination of the ith CPU resource and the jth GPU resource that have been selected to the calculation unit 134.

Upon input of the combination information from the selection unit 133, the calculation unit 134 refers to the straddling number table storage unit 124 to acquire a straddling number for each type of the virtual switch in a path between the ith CPU resource and the jth GPU resource included in the combination information. The calculation unit 134 refers to the weighting table storage unit 125 to acquire a weighting for each type of the virtual switch in the path. The calculation unit 134 calculates a switch straddling estimated number of the path in the selected combination based on the straddling number and the weighting for each type of the virtual switch that have been acquired (Step S17). The calculation unit 134 outputs the combination information and the calculated switch straddling estimated number to the determination unit 135.

Upon input of the combination information and the switch straddling estimated number from the calculation unit 134, the determination unit 135 determines whether the switch straddling estimated number is the minimum (Step S18). If the determination unit 135 determines that the switch straddling estimated number is not the minimum (No at Step S18), the determination unit 135 does not set the combination of the ith CPU resource and the jth GPU resource included in the combination information as a combination candidate (Step S19), and proceeds to Step S26.

If the determination unit 135 determines that the switch straddling estimated number is the minimum (Yes at Step S18), the determination unit 135 determines whether there is already a switch straddling estimated number of the same value (Step S20). If the determination unit 135 determines that there is no switch straddling estimated number of the same value (No at Step S20), the determination unit 135 sets the combination of the ith CPU resource and the jth GPU resource included in the combination information as a tentative combination (Step S21), and proceeds to Step S26.

If the determination unit 135 determines that there is already a switch straddling estimated number of the same value (Yes at Step S20), the determination unit 135 refers to the used bus table storage unit 126 to acquire the usage status of buses used by other logical servers. The determination unit 135 refers to the used bus table storage unit 126 to acquire the usage status of buses of a combination of the CPU resource and the GPU resource with the switch straddling estimated number of the same value (the existing tentative combination) (Step S22).

The determination unit 135 counts a bus interfering number of the existing tentative combination and the current combination included in the combination information each for the usage status of the buses used by the other logical servers (Step S23).

The determination unit 135 determines whether the current combination has a fewer bus interfering number (Step S24). If the determination unit 135 determines that the current combination has a fewer bus interfering number (Yes at Step S24), the determination unit 135 sets the current combination as the tentative combination (Step S25), and proceeds to Step S26. If the determination unit 135 determines that the bus interfering number of the current combination is not less than the bus interfering number of the tentative combination (No at Step S24), the determination unit 135 sets the existing tentative combination continuously as the tentative combination, and proceeds to Step S26.

The determination unit 135 determines whether there is a (j+1)th GPU resource (Step S26). If the determination unit 135 determines that there is a (j+1)th GPU resource (Yes at Step S26), the determination unit 135 increments j (Step S27), and returns to Step S16. If the determination unit 135 determines that there is no (j+1)th GPU resource (No at Step S26), the determination unit 135 determines whether there is an (i+1)th CPU resource (Step S28). If the determination unit 135 determines that there is an (i+1)th CPU resource (Yes at Step S28), the determination unit 135 increments i (Step S29), and returns to Step S15.

If the determination unit 135 determines that there is no (i+1)th CPU resource (No at Step S28), the determination unit 135 determines the CPU resource and GPU resource of the tentative combination as the resources to be used corresponding to the order information (Step S30). The determination unit 135 outputs information on the determined resources to be used to the generation unit 136.

Upon input of the information on the resources to be used from the determination unit 135, the generation unit 136 generates the logical server based on the information on the resources to be used (Step S31). The generation unit 136 stores information on the generated logical server in the resource table storage unit 121, the logical server table storage unit 122, and the used bus table storage unit 126. As a result, the information processing apparatus 100 can search for optimal resources from the resource pool 200.

Thus, the information processing apparatus 100 receives the order information of the logical server from the user using the computer systems including CDI. The information processing apparatus 100 acquires the unused resource information among the resources included in the tenant. The information processing apparatus 100 selects one or more combinations of resource candidates from the acquired unused resource information based on the order information. Based on the straddling number and the weighting for each type of the virtual switch between the resources, the information processing apparatus 100 calculates the switch straddling estimated number of the virtual switch in the path connecting the resource candidates in the selected combinations to each other. The information processing apparatus 100 determines the combination of the resource candidates that minimizes the switch straddling estimated number as resources to be used corresponding to the order information. As a result, the information processing apparatus 100 can search for optimal resources from the resource pool 200.

The information processing apparatus 100 adds a value obtained by multiplying the straddling number by the weighting by the number of the type of the virtual switch for each type of the virtual switch to calculate the switch straddling estimated number. As a result, the information processing apparatus 100 can search for optimal resources from the resource pool 200 in consideration of the physical distance and performance of the virtual switch.

When there are a plurality of combinations that minimize the switch straddling estimated number, the information processing apparatus 100, based on the usage status of the buses on the path, determines the number of the buses used by the other logical servers and included in the path for each combination. In addition, the information processing apparatus 100 determines the combination of the resource candidates with the number included in the path being fewer as the resources to be used. As a result, the information processing apparatus 100 can search for optimal resources from the resource pool 200 in consideration of the usage status of the resources of the other logical servers.

The resources are connected to each other with buses so as to be in a hierarchical structure via the virtual switch. As a result, the information processing apparatus 100 can search for optimal resources from the resource pool 200, which includes resources with different physical distances.

The information processing apparatus 100 monitors the resources and, when there is a defect resource, an increased resource, or a decreased resource, updates the information on the resources. Note that the increase and the decrease in resources here represent, for example, attaching and detaching hardware resources such as SSD cards (the NVMe SSDs 212 and 213) and GPU cards (the PCIe device 207) to and from the PCIe boxes 204 and 205. As a result, the information processing apparatus 100 can reflect the defect, increased, or decreased resources in the resource table storage unit 121, the administration table storage unit 123, the straddling number storage unit 124, and the used bus table storage unit 126.

The resources are one or more types of resources out of a CPU, a GPU, and an SSD. As a result, the information processing apparatus 100 can generate the logical server corresponding to the order information.

The type of the virtual switch is a PCIe fabric switch, a PCIe switch, and an NVMe switch. As a result, the information processing apparatus 100 can search for optimal resources from the resource pool 200, which includes resources with different physical distances.

In the above example, based on the order information that generates a new logical server, resource search is performed to generate the logical server, but this is not limiting. For example, it may be applied to resource search when resources are added to the existing logical server by the user. For example, when it is determined that a resource has been increased in the monitoring processing, search processing may be executed on the existing logical server to search for a more optimal resource.

In the above example, the information processing apparatus 100 generates a logical server, but this is not limiting. For example, the information processing apparatus 100 may transmit the information on the determined resources to be used to another information processing apparatus such as a switching apparatus, and the other information processing apparatus such as a switching apparatus may generate the logical server (switch the configuration).

Each component of each part illustrated does not necessarily need to be physically configured as illustrated. In other words, the specific form of dispersion and integration of each part is not limited to that illustrated, but the whole or part thereof can be configured by being functionally or physically dispersed and integrated in arbitrary units in accordance with various loads, usage conditions, and the like.

Furthermore, the various processing functions performed by each apparatus may be executed in whole or arbitrary part on a CPU (or a microcomputer such as an MPU or a micro controller unit (MCU)). It goes without saying that the various processing functions may be executed in whole or arbitrary part on a computer program that is analyzed and executed by a CPU (or a microcomputer such as an MPU or MCU) or on hardware by wired logic.

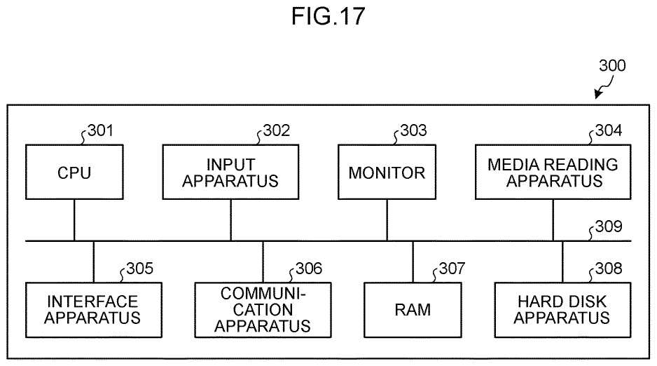

By the way, the various processing described in the above example can be implemented by executing a computer program prepared in advance on a computer. Thus, an example of a computer that executes a computer program having the same functions as those of the above example will be described below. FIG. 17 is a diagram of an example of a computer that executes a resource search program.

As illustrated in FIG. 17, this computer 300 has a CPU 301 that executes various arithmetic processing, an input apparatus 302 that receives data input, and a monitor 303. The computer 300 also has a media reading apparatus 304 that reads a computer program and the like from a storage medium, an interface apparatus 305 for connecting to various apparatuses, and a communication apparatus 306 for connecting to another information processing apparatus or the like in a wired or wireless manner. The computer 300 also has a RAM 307 that temporarily stores therein various information and a hard disk apparatus 308. Each of the apparatuses 301 to 308 is connected to a bus 309.

The hard disk apparatus 308 stores therein the resource search program having the same functions as those of the processing units including the receiving unit 131, the acquisition unit 132, the selection unit 133, the calculation unit 134, the determination unit 135, the generation unit 136, and the monitoring unit 137 illustrated in FIG. 4. The hard disk apparatus 308 also stores therein the resource table storage unit 121, the logical server table storage unit 122, the administration table storage unit 123, the straddling number table storage unit 124, the weighting table storage unit 125, and the used bus table storage unit 126. The input apparatus 302, for example, receives input of various information, such as operation information, from the administrator of the computer 300. The monitor 303, for example, displays various screens, such as a display screen, to the administrator of the computer 300. A printing apparatus or the like is connected to the interface apparatus 305, for example. The communication apparatus 306, for example, has the same functions as those of the communication unit 110 illustrated in FIG. 4, and is connected to the network N to exchange various information with the terminal apparatus 10, the resource pool 200, and the other information processing apparatus.

The CPU 301 reads each computer program stored in the hard disk apparatus 308, loads it into the RAM 307, and executes it to perform various processing. These computer programs can cause the computer 300 to function as the receiving unit 131, the acquisition unit 132, the selection unit 133, the calculation unit 134, the determination unit 135, the generation unit 136, and the monitoring unit 137 illustrated in FIG. 4.

Note that the resource search program does not necessarily need to be stored in the hard disk apparatus 308. For example, a computer program stored in a storage medium readable by the computer 300 may be read and executed by the computer 300. Examples of the storage medium readable by the computer 300 include portable storage media such as Compact Disc Read Only Memory (CD-ROM), Digital Versatile Disc (DVD), and Universal Serial Bus (USB) memories, semiconductor memories such as a flash memory, and hard disk drives. This resource search program may be stored in an apparatus connected to a public line, the Internet, a LAN, or the like, and the computer 300 may read the resource search program from these apparatuses and execute it.

Optimal resources can be searched for from the resource pool.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiment(s) of the present invention has(have) been described in detail, it should be understood that the various changes, substitutions, and alterations could be made hereto without departing from the spirit and scope of the invention.

What is claimed is:

1. A non-transitory computer-readable recording medium storing therein a resource search program that causes a computer to execute a process comprising:
receiving order information of a logical server from a user using a computer system including composable disaggregated infrastructure;
acquiring unused resource information among resources included in a tenant;
selecting one or more combinations of resource candidates from the acquired unused resource information based on the order information;
based on a straddling number and a weighting for each type of a virtual switch between the resources, calculating a switch straddling estimated number of the virtual switch of a path connecting the resource candidates in the selected combinations to each other; and
determining the combination of the resource candidates that minimizes the switch straddling estimated number as resources to be used corresponding to the order information.

2. The non-transitory computer-readable recording medium according to claim 1, wherein the process further includes adding a value obtained by multiplying the straddling number by the weighting by a number of a type of the virtual switch for each type of the virtual switch to calculate the switch straddling estimated number.

3. The non-transitory computer-readable recording medium according to claim 1, wherein when there are a plurality of the combinations that minimize the switch straddling estimated number, the process further includes, based on a usage status of buses on the path, determining a number of the buses used by other logical servers and included in the path for each of the combinations, and determining the combination of the resource candidates with the number included in the path being fewer as the resources to be used.

4. The non-transitory computer-readable recording medium according to claim 1, wherein the resources are connected to each other with buses so as to be in a hierarchical structure via the virtual switch.

5. The non-transitory computer-readable recording medium according to claim 1, wherein the process further includes monitoring the resources and, when there is a defect resource, an increased resource, or a decreased resource, updating information on the resources.

6. The non-transitory computer-readable recording medium according to claim 1, wherein the resources are one or more types of resources out of a central processing unit (CPU), a graphics processing unit (GPU), and a solid state drive (SSD).

7. The non-transitory computer-readable recording medium according to claim 1, wherein the type of the virtual switch is a PCIe fabric switch, a PCIe switch, and an NVMe switch.

8. A resource search method comprising:
receiving order information of a logical server from a user using a computer system including composable disaggregated infrastructure;
acquiring unused resource information among resources included in a tenant;
selecting one or more combinations of resource candidates from the acquired unused resource information based on the order information;
based on a straddling number and a weighting for each type of a virtual switch between the resources, calculating a switch straddling estimated number of the virtual switch of a path connecting the resource candidates in the selected combinations to each other; and
determining the combination of the resource candidates that minimizes the switch straddling estimated number as resources to be used corresponding to the order information, by a processor.

9. An information processing apparatus comprising:
a processor configured to:
receive order information of a logical server from a user using a computer system including composable disaggregated infrastructure;
acquire unused resource information among resources included in a tenant;
select one or more combinations of resource candidates from the acquired unused resource information based on the order information;
based on a straddling number and a weighting for each type of a virtual switch between the resources, calculate a switch straddling estimated number of the virtual switch of a path connecting the resource candidates in the selected combinations to each other; and
determine the combination of the resource candidates that minimizes the switch straddling estimated number as resources to be used corresponding to the order information.
